(19) United States
(12) Patent Application Publication
(10) Pub. No.: US 2007/0205090 A1
(43) Pub. Date: Sep. 6, 2007

(54) PORTABLE ELECTRONIC DEVICE

(75) Inventor: Hsin-Liang Chen, Keelung (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/669,055

(22) Filed: Jan. 30, 2007

(30) Foreign Application Priority Data
Mar. 3, 2006 (TW) TW95107151

(51) Int. Cl. H01H 13/72

(52) U.S. Cl. 200/5 B

(57) ABSTRACT

A portable electronic device. The portable electronic device includes a body and a button assembly. The body includes a top cover and a bottom cover. The button assembly includes a opening. The button assembly is movably disposed between the top cover and the bottom cover to move between a first position and a second position. When the button assembly is in the first position, the opening of the button assembly is exposed. When the button assembly is in the second position, the opening of the button assembly is hidden in the body.

### BACKGROUND OF THE INVENTION

1. Field of the Invention

The invention relates to a portable electronic device, and in particular, to a portable electronic device with push-push type mechanism.

2. Description of the Related Art

FIG. 1 depicts a conventional mobile phone 1 comprising a body 2 and an opening 3. The mobile phone 1 can be decorated by affixing an ornament in the opening 3. The opening 3 is, however, still exposed.

### BRIEF SUMMARY OF THE INVENTION

A portable electronic device with a button assembly, capable of easily receiving an opening, is provided. Accordingly, an exemplary embodiment of a portable electronic device comprises a body and a button assembly. The body comprises a top cover and a bottom cover. The button assembly is movably disposed on the body to move between a first position and a second position, and comprises an opening. When the button assembly is disposed in the first position, the opening of the button assembly is hidden in the body. When the button assembly is disposed in the second position, the button assembly is exposed outside the body. The top cover comprises a groove and the bottom cover comprises an indentation, and the button assembly is engaged between the groove and the indentation.

The button assembly comprises a first component, a second component, a helical spring, and a cap holder. The helical spring respectively abuts the first component and the second component. The cap holder is engaged with the first component. The cap holder comprises a hook and a pillar. The hook is engaged with the first component. The pillar is engaged in the groove.

The first component comprises a cam holder, a plurality of elastic elements, and a plurality of horizontal cams. The cam holder is engaged with the cap holder. The elastic elements are engaged with the cam holder. The horizontal cams abut the cam holder. The cam holder comprises a plurality of the first grooves and a plurality of the second grooves, and the elastic element is engaged with the first grooves and the horizontal cams movably abut the second grooves. The horizontal cams comprise a plurality of hooks and a plurality of first protrusions, the hooks movably abut the second grooves of the cam holder, and the helical spring is limited within the first protrusion. The elastic element comprises a supporting part and a bending part. The supporting part is engaged in the first groove. The bending part is connected to the supporting part and abuts the horizontal cam.

The second component comprises a vertical cam, a shaft, a c-ring, and a button. The vertical cam comprises a plurality of threads and a protrusion. The shaft passes through the vertical cam, and comprises a plurality of third grooves. The c-ring is engaged with the third grooves of the shaft. The button is closely fitted with the vertical cam via the threads. When the button assembly is in the first position, the horizontal cam abuts the shaft and the vertical cam, the horizontal cam abuts the elastic elements, thus, the opening of the button is exposed. When the button assembly is in the second position, the hooks of the horizontal cams are engaged with the protrusion of the vertical cam, the shaft abuts the vertical cam, thus, the opening of the button is hidden in the body.

The shaft further comprises a narrow part and a third protrusion. When the button assembly is in the first position, the narrow part abuts the horizontal cam. When the button assembly is in the second position, the third protrusion of the shaft abuts the vertical cam.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional mobile phone;

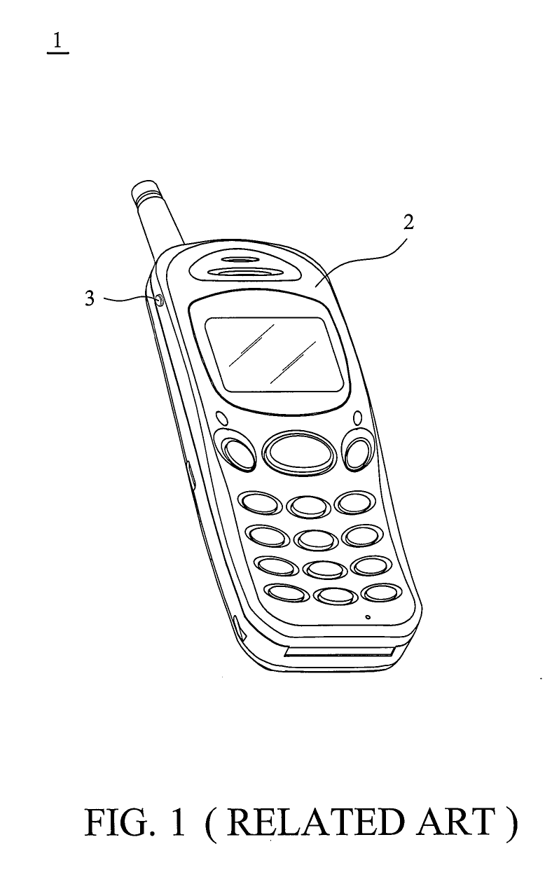

FIG. 2 is an exploded schematic view of a first embodiment of a portable electronic device;

FIG. 3 is an exploded schematic view of a button assembly;

FIG. 4 is a schematic view of combining the cam holder and the elastic elements;

FIG. 5 is a schematic view of assembling a first component;

FIG. 6 is a schematic view of assembling a second component;

FIG. 7 is a detailed schematic view of a cap holder;

FIG. 8 is a schematic view of assembling a button assembly;

FIG. 9 is a schematic view of the surface of the button assembly, wherein the button assembly is in the first position;

FIG. 10 is a sectional view along line A-A′ in FIG. 9;

FIG. 11 is a sectional view along line A-A′ of the button assembly, wherein the button assembly is being pressed and received;

FIG. 12 is a sectional view along line A-A′ of the button assembly, wherein the button assembly is in the second position;

FIG. 13 is a surface schematic view in FIG. 12;

FIG. 14 is a sectional view along line A-A′ of the button assembly, wherein the button assembly is being exposed; and

FIG. 15 is a sectional view along line A-A′ of the button assembly, wherein the button assembly is being exposed.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

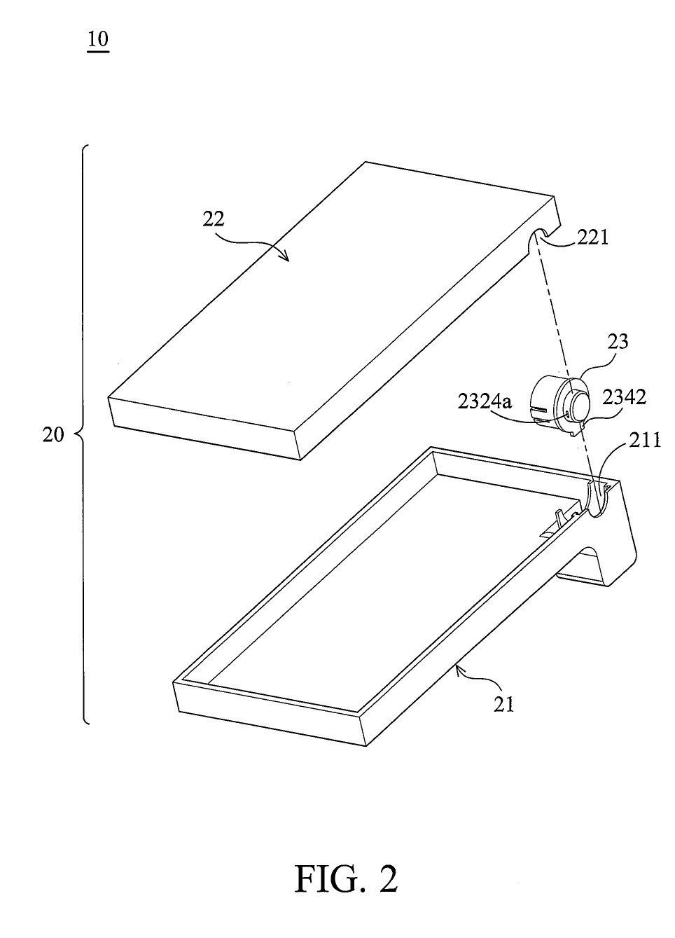

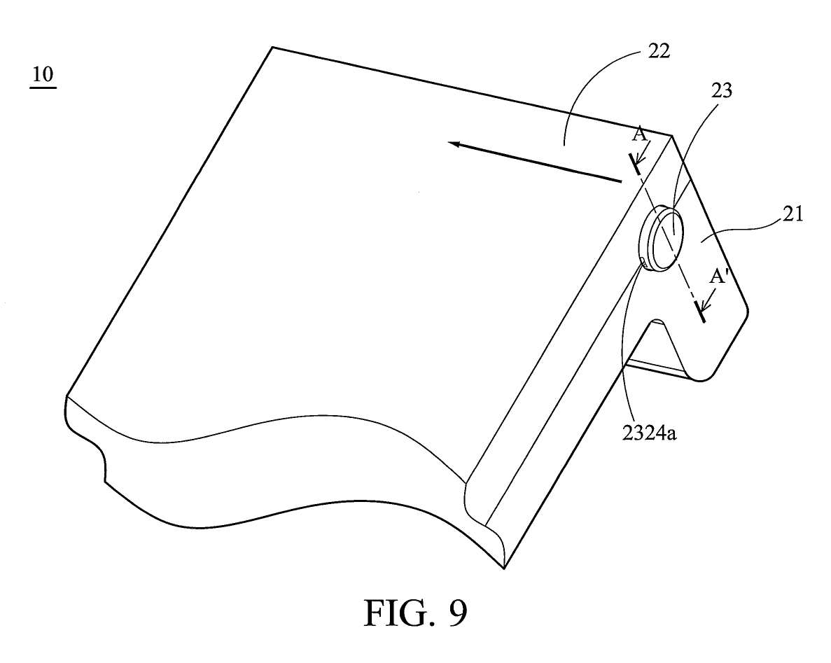

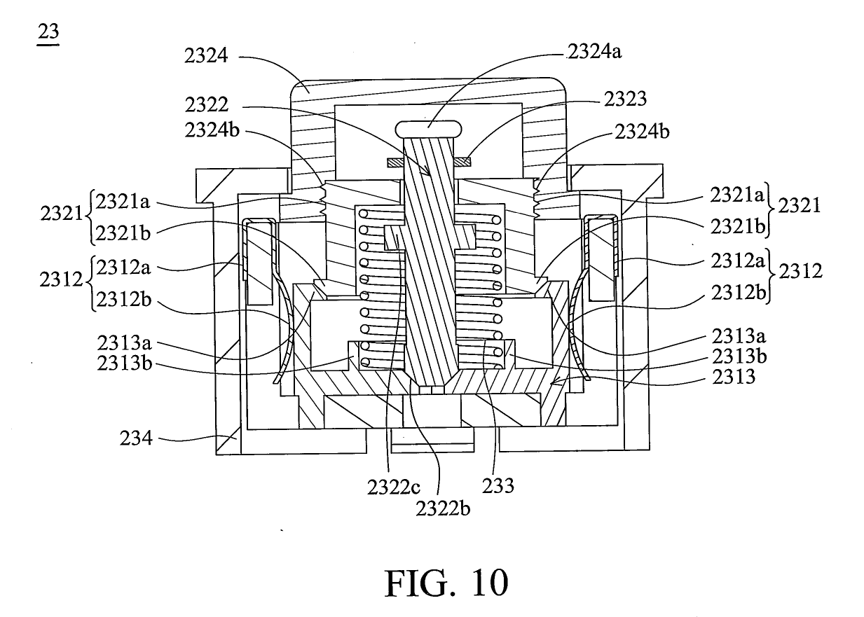

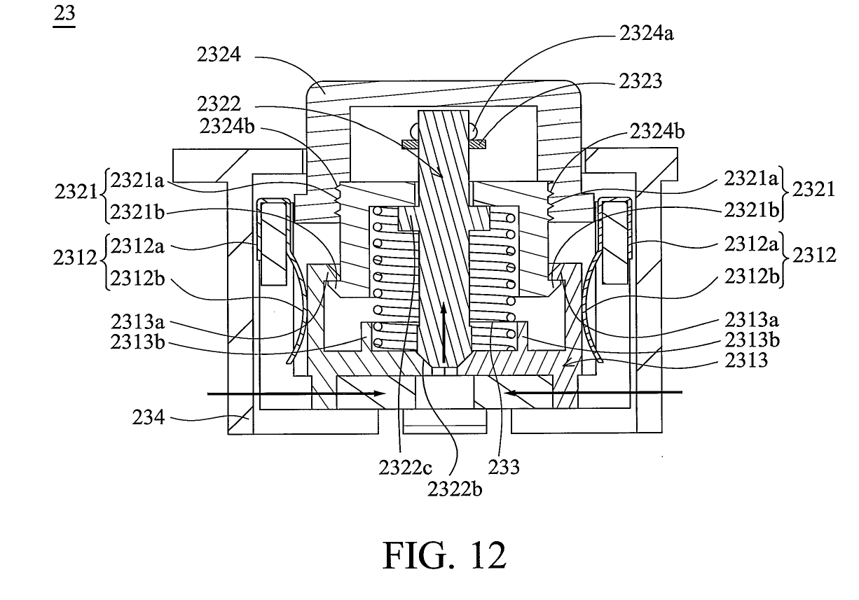

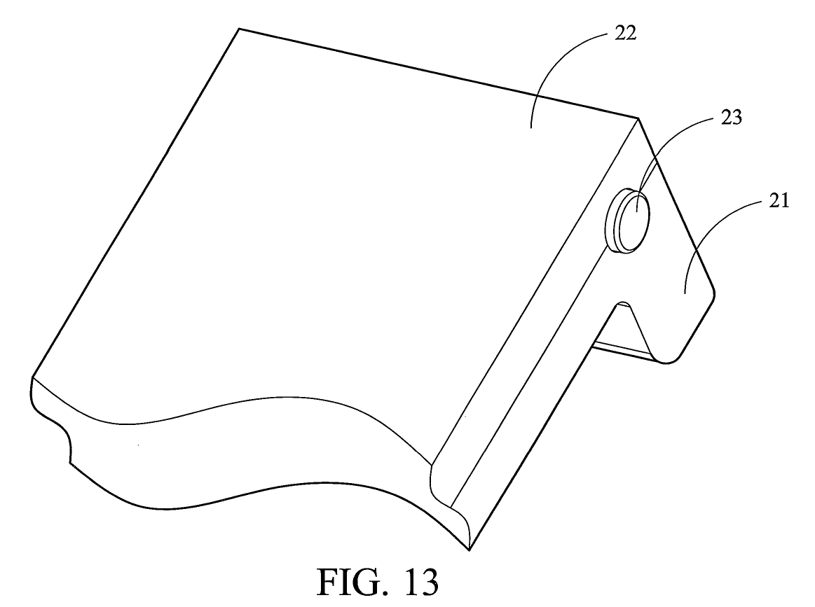

Referring to FIG. 2, a portable electronic device 10 comprises a body 20 and a button assembly 23. The body 20 comprises a top cover 21 and a bottom cover 22(the position of the top cover 21 and the bottom cover 22 are exchanged for clarity in FIG. 2). The top cover 21 and the bottom cover 22 respectively comprise a groove 211 and an indentation 221. The button assembly 23 comprises a opening 2324a, and is movably disposed between the groove 211 of the top cover 21 and the indentation 221 of the bottom cover 22 to move between a first position (as shown in FIG. 9 and FIG. 10, detailed descriptions of which are described in the following) and a second position (as shown in FIG. 12 and FIG. 13, detailed descriptions will be described below). When the button assembly 23 is in the first position, the opening 2324a of the button assembly 20 is exposed outside the body 20. When the button assembly 23 is in the second position the opening 2324a is hidden in the body 20.

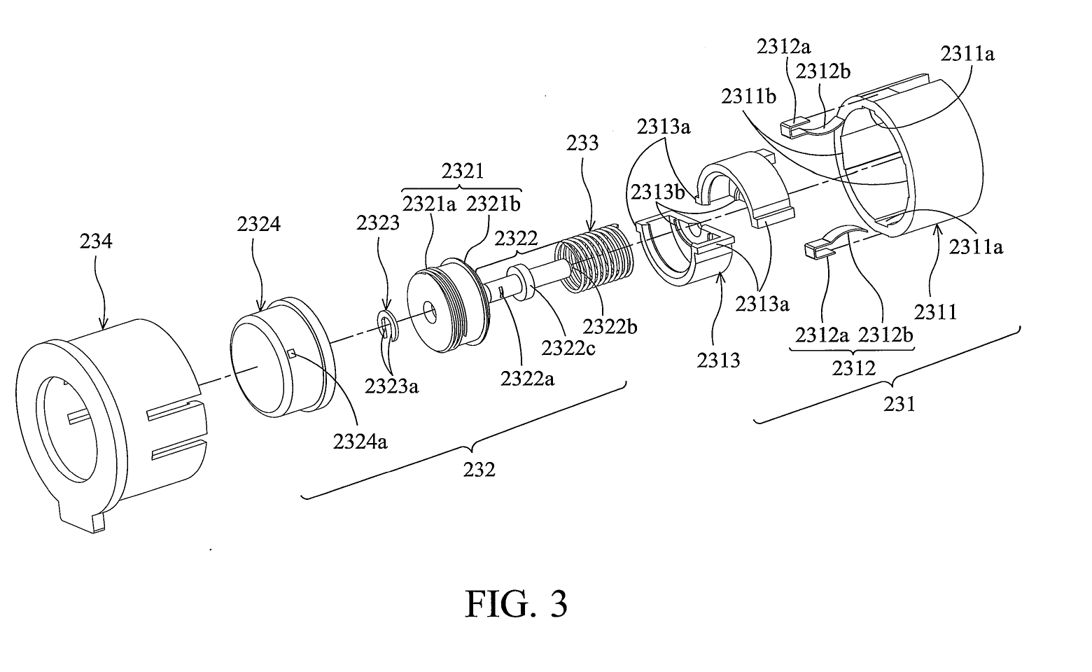

Referring to FIG. 3, the button assembly 23 is a push-push type mechanism, comprising a first component 231, a second component 232, a helical spring 233, and a cap holder 234. The first component 231 comprises a cam holder 2311, two elastic elements 2312, and two horizontal cams 2313. The cam holder 2322 comprises two first grooves 2311a and two second grooves 2311b. Each elastic element comprises a supporting part 2311a and a bending part 2312b. Each horizontal cam 2313 respectively comprises two first hooks 2313a and two first protrusions 2313b.

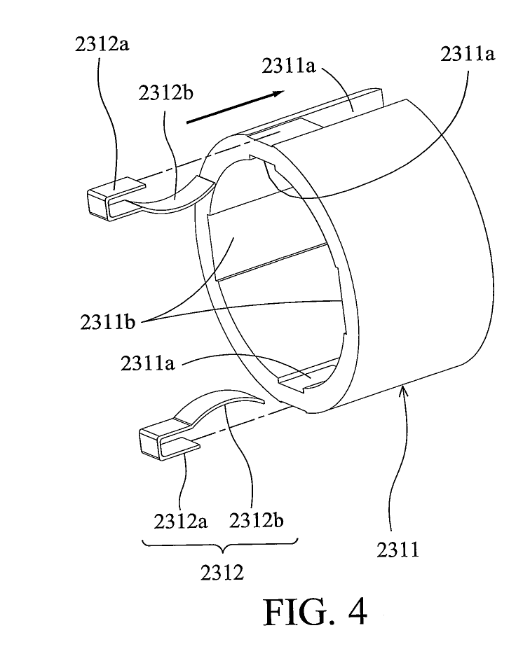

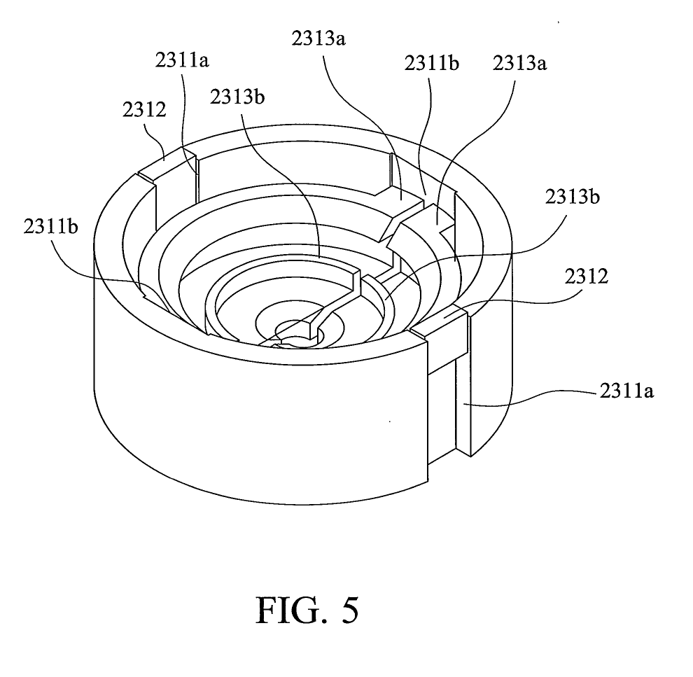

Referring to FIG. 4, the first component 231 is first combined with the elastic elements 2312. The bending parts 2312b of the elastic elements 2312 abut the horizontal cam 2313, and the supporting parts 2311a are engaged in the first grooves 2311a. Referring to FIG. 5, the horizontal cam 2311 is disposed in the cam holder 2311, and the first hooks of the horizontal cam 2311 movably abut the second grooves 2311b, thus, the helical spring 233 is limited within the first protrusions 2313b, as shown in FIG. 10.

Referring to FIG. 3, the second component 232 comprises a vertical cam 2321, a shaft 2322, a c-ring 2323, and a button 2324. The vertical cam 2321 comprises a plurality of threads 2321a and a flange 2321b. The shaft 2322 comprises a plurality of third grooves 2321a, a narrow part 2322b, and a third protrusion 2322c. The button 2324 comprises an opening 2324a and internal threads 2324b (as shown in FIG. 10).

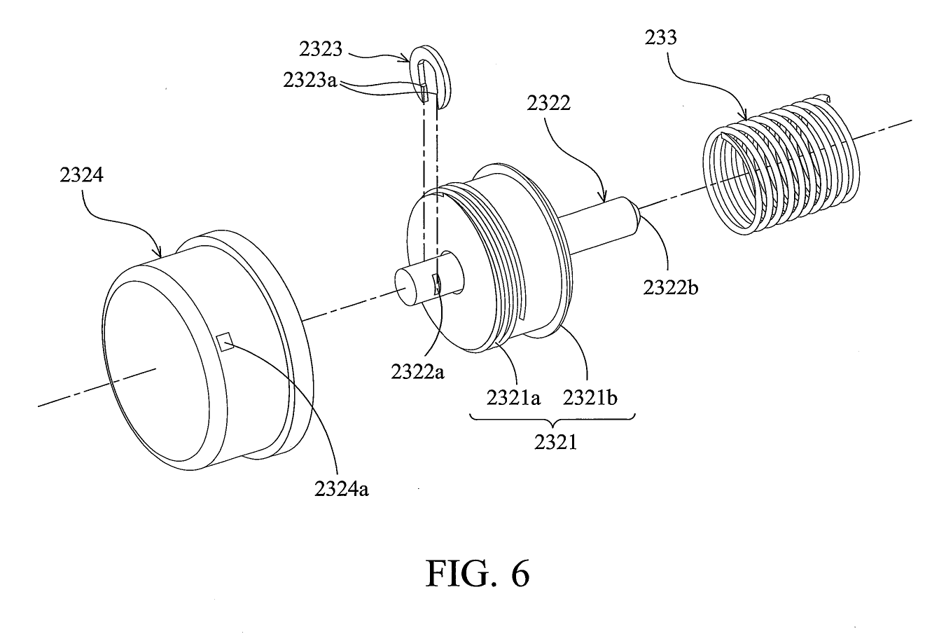

Referring to FIG. 6, the third grooves 2321a of the shaft 2322 and the threads 2321a of the vertical cam 2321 are at the left side of FIG. 6, and the narrow part 2322b and the flange 2321b of the vertical cam 2321 are at the right side of FIG. 6. When assembling the second component 232, the shaft 2322 passes through the vertical cam 2321, and then the c-ring 2323 is engaged in the third grooves 2321a. Subsequently, the internal threads 2324b of the button 2324 lock with the threads 2321a of the vertical cam 2321.

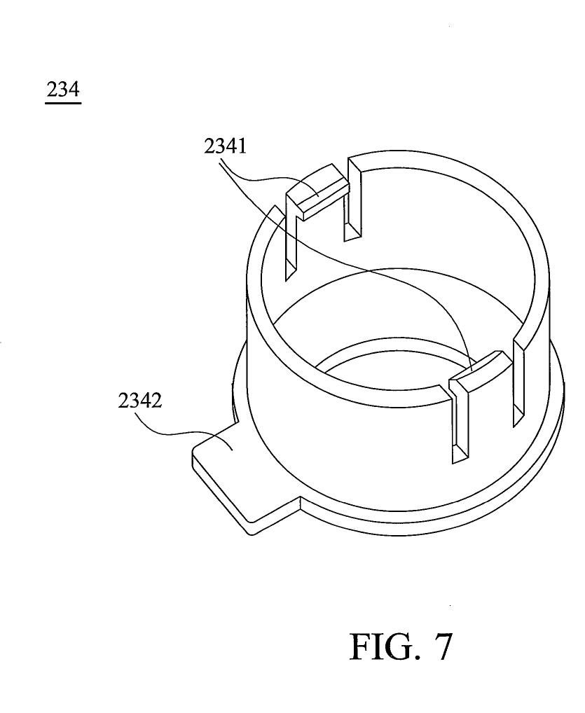

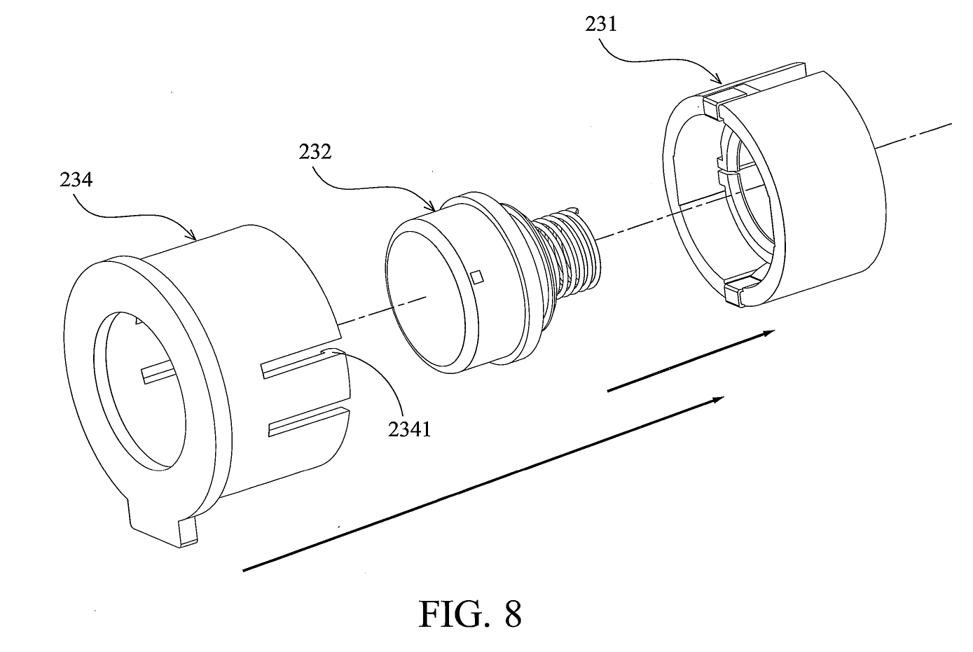

Referring to FIG. 7, the cap holder 234 comprises a plurality of second hooks 2341 and a pillar 2342. Referring to FIG. 8, when assembling the button assembly 23, the second component 232 is disposed between the first component 231 and the cap holder 234, and the second hooks 2341 of the cap holder 234 are engaged with the first component 231. Referring again to FIG. 2, the assembled button assembly 23 is disposed between the top cover 21 and the bottom cover 22, and the pillar 2342 of the cap holder 234 is engaged with the groove 211 of the top cover 21, to dispose the button assembly 23 on the portable electronic device 10. As shown in FIG. 9, the opening 2324a of the button is exposed outside the portable electronic device 10.

Referring to FIG. 10, before the button assembly 23 of the portable electronic device 10 is pressed, which is called the first position, the horizontal cams 2313 abut the shaft 2322, the vertical cam 2321 and the elastic elements 2312, so that the opening 2324a of the button 2324 is exposed outside the body 20 and the ornament can be hung on the opening 2324a.

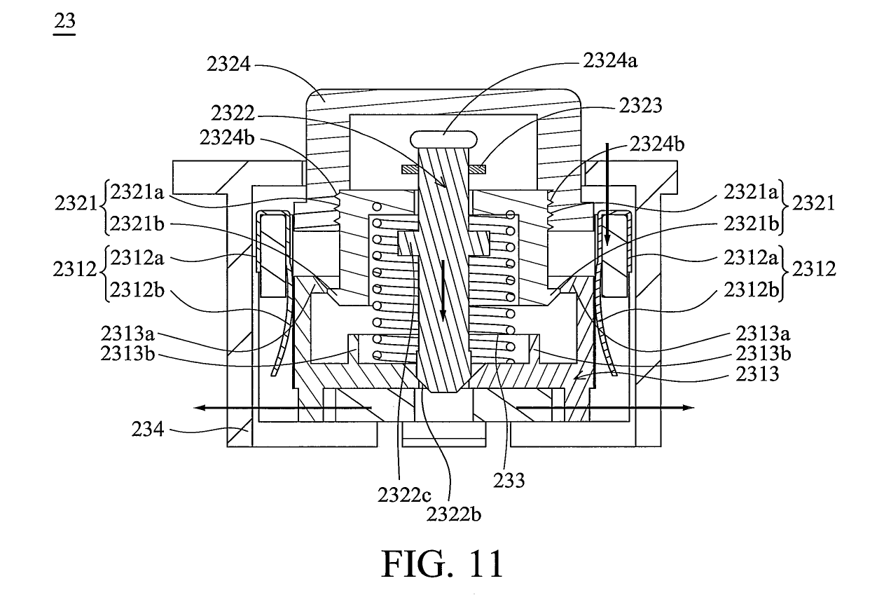

Referring to FIG. 11, when the ornament is removed, the button assembly 23 can be pressed in a pressed direction indicated by the vertical arrow in FIG. 11, to hide the opening 2324a. During the pressing process, the shaft 2322 and the vertical cam 2321 are moved downward together with the button 2324, and the helical spring 2322 is pressed. Additionally, the narrow part 2322b of the shaft 2322 presses against the horizontal cams 2313, so that two horizontal cams 2313 are respectively moved in two opposite directions as shown by the horizontal arrow in FIG. 11. Thus, a restoring force of the elastic elements 2312 is formed. Furthermore, the horizontal cams 2313 cannot move continuously in two opposite directions due to pressure of the elastic elements 2312, thus, the flange 2321b of the vertical cam 2321 abuts the internal of the first hooks 2313a.

Referring to FIG. 12, when the button 2324 is pressed continuously, the vertical cam 2321 is engaged with the interior of the first hooks 2313a. Subsequently, the pressed helical spring 233 expands upward and the shaft 2322 is moved by the helical spring 233, thus, the horizontal cam 2313 returns to its original position where the button assembly 23 is in the not pressed condition. When the shaft 2322 is moved upward and the third protrusion 2322c abuts the vertical cam 2321, the button assembly 23 moves to the second position. Thus, the opening 2324a is hidden in the body 20, as shown in FIG. 13.

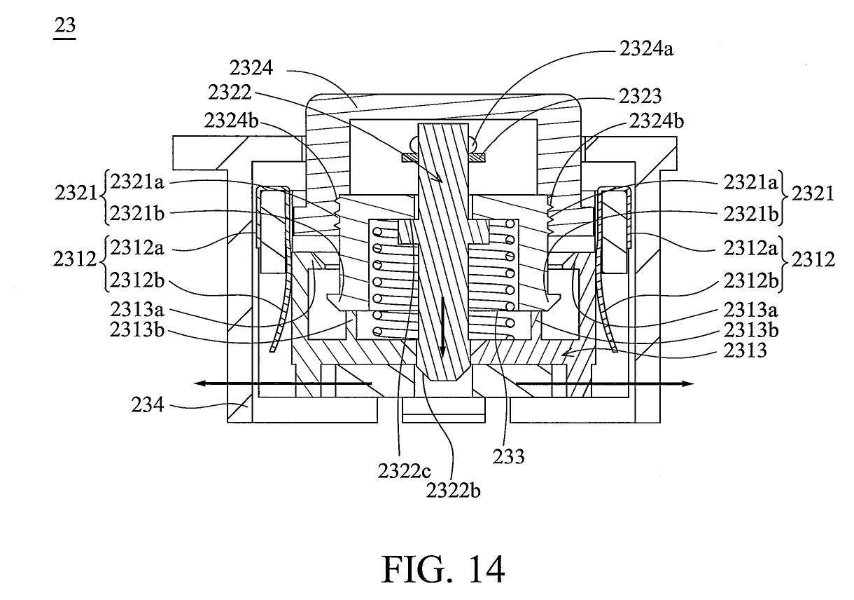

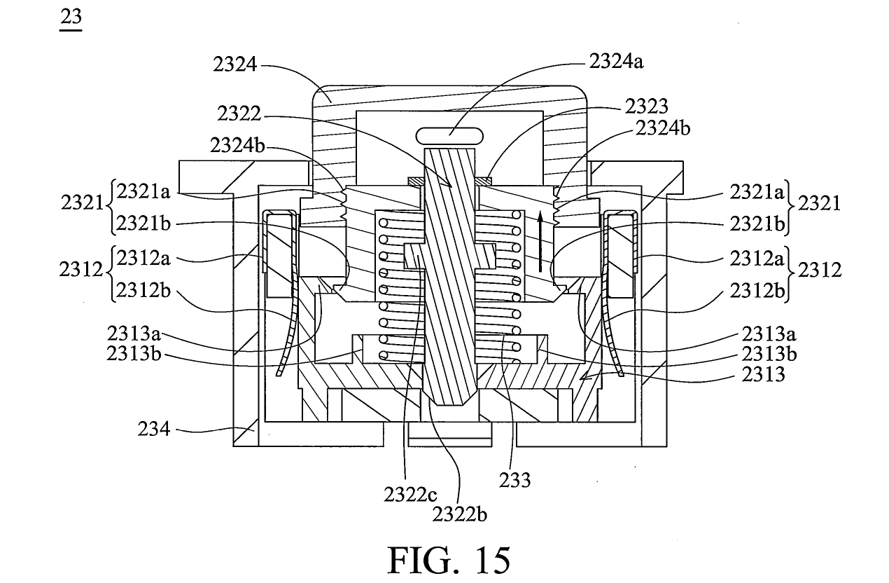

When the ornament is again hung, referring to FIG. 14, the button 2324 is pressed in a pressed direction as shown by the vertical arrow in FIG. 14, and the vertical cam 2321 presses the third protrusion 2322c of the shaft 2322 so that the shaft 2322 is moved downward. The narrow part 2322b of the shaft 2322 is pressed and the horizontal cams 2313 are moved in two opposite directions, thus, the helical spring 233 is compressed. When the vertical cam 2321 abuts the first protrusion 2313b of the horizontal cam 2313b, the vertical cam 2321 is limited so that it cannot move downward. Additionally, the horizontal cam 2313 is pressed by the elastic elements 2312 and cannot move in opposite direction, thus, the shaft 2322 is clipped by the horizontal cam 2313 and cannot move. Referring to FIG. 15, the helical spring 233 expands upward so that the vertical cam 2321 is pushed upward. When the flange 2321b of the vertical cam 2321 abuts the first protrusions 2313a and the vertical cam 2321 abuts the c-ring 2322, the vertical cam 2321 is moved upward by the shaft 2322, thus, the button 2324 returns to the first position (as shown in FIG. 10), thus, the opening 2324a of the button 2324 is exposed outside the body 20(as shown in FIG. 9), and the ornament can be easily disposed on the opening 2324a.

The button assembly 23 of the portable electronic device 10 is utilized to determine the positions of the opening 2324a. To use the opening 2324a, the opening 2324a can be exposed by only pressing the button 2324.

When the opening 2324a is not use, the opening 2324a can be hidden in the body 20 by pressing the button 2324 again.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable electronic device, comprising:
a body comprising a top cover and a bottom cover; and
a button assembly movably disposed between the top cover and the bottom cover to move between a first position and a second position, and comprising a opening,
wherein when the button assembly is in the first position, the opening of the button assembly is exposed, when the button assembly is in the second position, the opening of the button assembly is hidden in the body.

2. The portable electronic device as claimed in claim 1, wherein the top cover comprises a groove and the bottom cover comprises an indentation, and the button assembly is engaged between the groove and the indentation.

3. The portable electronic device as claimed in claim 2, wherein the button assembly comprises:
a first component;
a second component;
a helical spring respectively abutting the first component and the second component; and
a cap holder engaged with the first component.

4. The portable electronic device as claimed in claim 2, wherein the cap holder comprises a plurality of hooks engaged with the first component.

5. The portable electronic device as claimed in claim 3, wherein the cap holder comprises a pillar engaged to the groove.

6. The portable electronic device as claimed in claim 3, wherein the first component comprises:
a cam holder engaged with the cap holder;
a plurality of elastic elements engaged with the cam holder; and
a plurality of horizontal cams abutting the cam holder.

7. The portable electronic device as claimed in claim 6, wherein the cam holder comprises a plurality of first grooves and a plurality of second grooves, the elastic elements are engaged with the first grooves and the horizontal cam are movably abutted to the second grooves.

8. The portable electronic device as claimed in claim 7, wherein the horizontal cam comprises a plurality of second hooks and a plurality of first protrusions, the second hooks movably abut the second grooves of the cam holder, and the helical spring is confined within the first protrusions.

9. The portable electronic device as claimed in claim 8, the elastic element comprises:
a supporting part engaged in the first grooves; and
a bending part connected with the supporting part, and abutting the horizontal cam.

10. The portable electronic device as claimed in claim 9, wherein the second component comprises:
a vertical cam comprising a plurality of threads and a flange;
a shaft passing through the vertical cam, and comprising a plurality of third grooves; and
a c-ring engaged with the third grooves of the shaft; and
a button closely fitted with the vertical cam via the threads, wherein when the button assembly is in the first position, the horizontal cam abuts the shaft and the vertical cam, and the horizontal cam abuts the elastic elements to expose the opening, when the button assembly is in the second position, the second hooks of the horizontal cam engage the flange of the vertical cam and the shaft abuts the vertical cam so that the opening of the button is hidden in the body.

11. The portable electronic device as claimed in claim 10, wherein the shaft further comprises a narrow part, when the button assembly is in the first position, the narrow part abuts the horizontal cam.

12. The portable electronic device as claimed in claim 11, wherein the shaft further comprises a third protrusion, when the button assembly is in the second position, the third protrusion of the shaft abuts the vertical cam.

13. A push-push type mechanism, disposed on a electronic device, comprising:
a button assembly movably disposed on the electronic device to move between a first position and a second position, and comprising a opening, wherein when the button assembly is in the first position, the opening of the button assembly is exposed outside the electronic device, when the button assembly is in the second position, the opening of the button assembly is hidden in the electronic device.

14. The push-push type mechanism as claimed in claim 13, wherein the button assembly comprises:
a first component;
a second component;
a helical spring respectively abut the first component and the second component; and
a cap holder engaged with the first component.

15. The push-push type mechanism as claimed in claim 14, wherein the cap holder comprises a hook engaged with the first component.

16. The push-push type mechanism as claimed in claim 14, wherein the first component comprises:
a cam holder engaged with the cap holder;
a plurality of elastic elements engaged with the cam holder; and
a plurality of horizontal cam abutting the cam holder.

17. The push-push type mechanism as claimed in claim 16, wherein the cam holder comprises a plurality of first grooves and a plurality of second grooves, the elastic element is engaged with the first grooves and the horizontal cam is movably abutted to the second grooves.

18. The push-push type mechanism as claimed in claim 17, wherein the horizontal cam comprises a plurality of second hooks and a plurality of first protrusions, the hooks movably abut the second second grooves of the cam holder, and the helical spring is confined within the first protrusion.

19. The push-push type mechanism as claimed in claim 18, wherein the elastic element comprises:
a supporting part engaged in the first grooves; and
a bending part connected with the supporting part, and abutting the horizontal cam.

20. The push-push type mechanism as claimed in claim 19, wherein the second component comprises:
a vertical cam comprising a plurality of threads and a flange;
a shaft passing through the vertical cam, comprising a plurality of third grooves; and
a c-ring engaged with the third grooves of the shaft; and
a button closely fitted with the vertical cam by the threads, wherein when the button assembly is in the first position, the horizontal cam abuts the shaft and the vertical cam, and the horizontal cam abuts the elastic elements so that the opening of the button is exposed, when the button assembly is in the second position and the second hooks of the horizontal cam are engaged with the flange of the vertical cam, the shaft abuts the vertical cam so that the opening of the button is hidden in the body.

21. The push-push type mechanism as claimed in claim 20, wherein the shaft further comprises a narrow part, when the button assembly is in the first position, the narrow part abuts the horizontal cam.

22. The push-push type mechanism as claimed in claim 21, wherein the shaft further comprises a third protrusion, when the button assembly is in the second position, the third protrusion of the shaft abuts the vertical cam.
